(19) United States
(12) Patent Application Publication
(10) Pub. No.: US 2016/0246953 A1
(43) Pub. Date: Aug. 25, 2016

(54) USER FINGERPRINT AUTHENTICATION SYSTEM

(71) Applicant: Maria Wentzell, Hoover, AL (US)

(72) Inventor: Maria Wentzell, Hoover, AL (US)

(21) Appl. No.: 15/003,720

(22) Filed: Jan. 21, 2016

Related U.S. Application Data
(60) Provisional application No. 62/118,323, filed on Feb. 19, 2015.

(51) Int. Cl. G06F 21/32; G06K 9/00; H04L 9/32

(52) U.S. Cl. CPC G06F 21/32; H04L 9/3231; G06K 9/00087

(57) ABSTRACT

An integrated authentication system for automatically inputting a particular user's stored login credentials for an active process, such as a software application or website is employed on a conventional mobile device, such as a smartphone or tablet, through the use of a fingerprint scanner apparatus defining a conventional fingerprint recognition device having a conventional fingerprint sensor and memory for storing fingerprints and an input software application operative to identify the active process on the mobile device and retrieve and enter store login credentials based on an input from the fingerprint scanner apparatus.

### CROSS REFERENCE TO RELATED APPLICATIONS

This application claims the benefit of and incorporates by reference co-pending U.S. provisional patent application Ser. No. 62/118,323 filed Feb. 19, 2015.

### BACKGROUND OF THE INVENTION

1. Field of the Invention

This invention relates generally to biometric authentication and, more particularly, to a fingerprint authentication system for electronic devices.

2. Description of the Prior Art

The use of mobile computers, such as laptops, tablets, and smartphones, is well known. The use of such personal electronic devices and/or mobile devices has become ubiquitous in today's society, and users commonly access secure websites and content on such devices. As access to such content is generally restricted by passwords, a problem which still exists, is that users are often forced to remember many different passwords to access their secured content. Compounding this issue is the general recommended that people employ many different obscure passwords in order to enhance security. Thus, there remains a need for an integrated authentication system operative to store and automatically input passwords into websites and applications as desired by a user. It would be helpful if such an integrated authentication system employed a biometric access system to manage the input of stored passwords. It would be additionally desirable for such an integrated authentication system to be implemented through a fingerprint scanner and background application running on the mobile device so as to be available for use at all times.

The Applicant's invention described herein provides for an integrated authentication system adapted to allow a user to generate, store and automatically input a plurality of distinct passwords on their mobile device. The primary aspects in Applicant's integrated authentication system are a fingerprint scanner and a software application. When in operation, the integrated authentication system enables more a user to securely store and subsequent input passwords on command, thereby alleviating the need to remember so many different passwords. As a result, many of the limitations imposed by prior art structures are removed.

### SUMMARY OF THE INVENTION

An integrated authentication system for automatically inputting a particular user's stored login credentials for an active process, such as a software application or website. The integrated authentication system is employed on a conventional mobile device, such as a smartphone or tablet, through the use of a fingerprint scanner apparatus defining a conventional fingerprint recognition device having a conventional fingerprint sensor and memory for storing fingerprints and an input software application operative to identify the active process on the mobile device and retrieve and enter store login credentials based on an input from the fingerprint scanner apparatus.

It is an object of this invention to provide an integrated authentication system operative to store and automatically input passwords into websites and applications as desired by a user.

It is another object of this invention to provide an integrated authentication system which employed a biometric access system to manage the input of stored passwords.

It is yet another object of this invention to provide an integrated authentication system which is implemented through a fingerprint scanner and background application software running on the mobile device so as to be available for use at all times.

These and other objects will be apparent to one of skill in the art.

### BRIEF DESCRIPTION OF THE DRAWINGS

FIG. 1 is a back elevational view of a mobile device having a fingerprint scanner built in accordance with the present invention.

FIG. 2 shows the steps through which an integrated authentication system of a mobile device having a fingerprint scanner automatically inputs stored text authentication information for an active login.

### DETAILED DESCRIPTION OF THE INVENTION

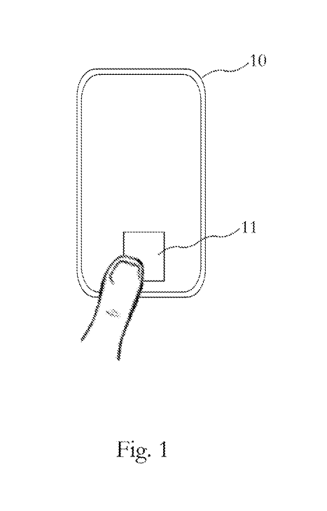

Referring now to the drawings and in particular FIG. 1, an integrated authentication system is employed on a conventional mobile device 10, such as a smartphone or tablet, through the use of a fingerprint scanner apparatus 11. The fingerprint scanner apparatus 11 defines a conventional fingerprint recognition device having a conventional fingerprint sensor and memory for storing fingerprints. When housed on a mobile device 10, the fingerprint scanner apparatus 11 is electrically connected to the microcontroller and power source of the mobile device.

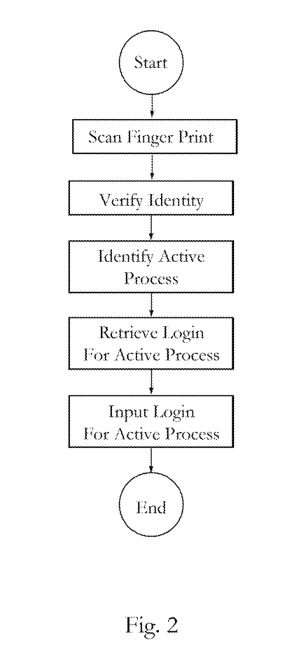

Referring now to FIG. 2, the integrated authentication system employs a background running input software application to automatically input stored user login credentials, such as a password and/or username, into a target website or software application interface when a verified user (a user who has verified their identity by having fingerprints stored in the fingerprint scanner apparatus) places their finger on the fingerprint scanner apparatus. When a finger is placed on the fingerprint scanner apparatus of an operative mobile device and held there for a predetermined period of time, the fingerprint scanner apparatus compares the fingerprint of the finger to fingerprints previously stored in its memory. In the preferred embodiment, the predetermined period of time defines three seconds. If the identity of a verified user is confirmed, the fingerprint scanner apparatus communicates with the input software application of the operative mobile device through its microcontroller the identity of the verified user. The input software application then identifies the website or software application interface that is active on the operative mobile device, retrieves from the operative mobile device's memory the required login credentials, and causes said credentials to be input into the website or software application interface.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for automatically inputting login credentials into an active process, comprising the steps of:
verifying through a fingerprint scanning apparatus the identity of a user of a mobile device, wherein said fingerprint scanning apparatus is housed by said mobile device;
identifying by a processor in the mobile device an active process, wherein said active process defines a software application having a user interface presently displayed on a display screen housed by said mobile device;
retrieving by said processor stored login credentials for the identified active process; and
inputting by said processor the stored login credentials for the identified active process into the user interface.

2. The method of claim 1, wherein the step of verifying includes scanning by the fingerprint scanning apparatus at least one current fingerprint of the user.

3. The method of claim 2, wherein the step of verifying includes comparing the at least one current fingerprint scanned to at least one stored fingerprint.

4. The method of claim 1, wherein the step of identifying is performed only once the identity of the user of a mobile device has been verified and communicated from the fingerprint scanning apparatus to the processor.

5. The method of claim 1, wherein said software application is defined by at least one of a desktop application and a web application.
